(19) United States
(12) Patent Application Publication
(10) Pub. No.: US 2016/0348003 A1
(43) Pub. Date: Dec. 1, 2016

(54) LIQUID CRYSTAL COMPOSITION AND LIQUID CRYSTAL DISPLAY DEVICE INCLUDING THE SAME

(71) Applicant: Samsung Display Co., Ltd., Gyeonggi-do (KR)

(72) Inventors: Minhee KIM, Gyeonggi-do (KR); Misuk KIM, Gyeonggi-do (KR); Taeho KIM, Gyeonggi-do (KR); Sunghwan HONG, Gyeonggi-do (KR)

(73) Assignee: Samsung Display Co., Ltd., Gyeonggi-do (KR)

(21) Appl. No.: 14/960,892

(22) Filed: Dec. 7, 2015

(30) Foreign Application Priority Data
May 26, 2015 (KR) 10-2015-0073199

(51) Int. Cl. C09K 19/54; G02F 1/1335; G02F 1/1343; C09K 19/30; G02F 1/1337

(52) U.S. Cl. CPC C09K 19/54; C09K 19/3003; G02F 1/1337; G02F 1/134363; G02F 1/133514; C09K 2019/3004

(57) ABSTRACT

A liquid crystal composition includes an amine light stabilizer including a first compound represented by Formula 1 and a second compound represented by Formula 2; and a liquid crystal:

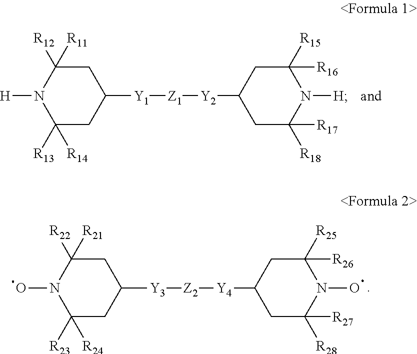

This application claims priority to Korean Patent Application No. 10-2015-0073199, filed on May 26, 2015, and all the benefits accruing therefrom under 35 U.S.C. §119, the entire content of which is hereby incorporated by reference.

### BACKGROUND

1. Field

One or more exemplary embodiments relate to a liquid crystal composition and a liquid crystal display device including the same.

2. Description of the Related Art

Liquid crystal display devices are flat panel display devices that are widely used. A liquid crystal display device includes two display panels including field generating electrodes, such as a pixel electrode and a common electrode; and a liquid crystal layer disposed between the display panels. Liquid crystal display devices display an image in such a manner that a voltage is applied to field generating electrodes to generate an electric field in a liquid crystal layer, thereby determining the alignment of liquid crystal molecules constituting the liquid crystal layer and controlling polarization of incident light.

Depending on how the alignment of liquid crystal molecules of the liquid crystal layer is controlled, liquid crystal display devices can be classified as a twisted nematic (“TN”) mode liquid crystal display device, a vertical alignment (“VA”) mode liquid crystal display device, an in-plane switching (“IPS”) mode liquid crystal display device, a plane-to-line switching (“PLS”) mode liquid crystal display device or a fringe field switching (“FFS”) mode liquid crystal display device.

Among these liquid crystal display devices, the PLS mode liquid crystal display device includes a pixel electrode and a common electrode located together on a substrate, horizontally controls the alignment of liquid crystal molecules in a liquid crystal layer due to an electric field between the pixel electrode and the common electrode, and has a wide viewing angle and a high response speed.

In manufacturing the PLS mode liquid crystal display device, an alignment process is performed by using photo-alignment technology, which is a non-contact-type process, or rubbing, which is a contact-type process. The photo-alignment technology is preferred.

When the photo-alignment technology is used; however, materials used in manufacturing liquid crystal display devices absorb ultraviolet (“UV”) light, generating radicals or ions, which leads to a decrease in a voltage holding ratio (“VHR”), face image sticking and line image sticking.

### SUMMARY

One or more exemplary embodiments include a liquid crystal composition for reducing the occurrence of face image sticking and/or line image sticking, and a liquid crystal display device including the liquid crystal composition.

Additional aspects will be set forth in part in the description which follows and, in part, will be apparent from the description, or may be learned by practice of the presented embodiments.

In an exemplary embodiment, a composition for liquid crystal includes an amine light stabilizer including a first compound represented by Formula 1 and a second compound represented by Formula 2, and a liquid crystal:

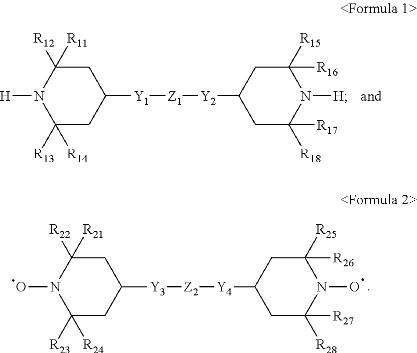

In an aspect of the exemplary embodiment, in Formulae 1 and 2:

Z₁ and Z₂ may be each independently selected from a substituted or unsubstituted C₁-C₂₀ alkylene group, a substituted or unsubstituted C₂-C₂₀ alkenylene group and a substituted or unsubstituted C₃-C₃₀ cycloalkylene group;

Y₁ to Y₄ may be each independently selected from *—O—*′, —(C═O)—O—*′, *—O—(C═*′ and *—O—(C═O)—O—*′;

R₁₁ to R₁₈ and R₂₁ to R₂₈ may be each independently selected from hydrogen, a substituted or unsubstituted C₁-C₂₀ alkyl group and a substituted or unsubstituted C₁-C₂₀alkoxy group;

at least one substituent of the substituted C₁-C₂₀ alkylene group, substituted C₂-C₂₀ alkenylene group, substituted C₃-C₃₀ cycloalkylene group, substituted C₁-C₂₀ alkyl group and substituted C₁-C₂₀ alkoxy group may be selected from fluorine, chlorine, bromine, iodine, a cyano group, a C₁-C₅ alkyl group and a C₁-C₅ alkoxy group;

O. is an oxygen radical; and

each of * and *′ is a binding site to a neighboring atom.

According to one or more exemplary embodiments, a liquid crystal display device includes a first substrate; a second substrate facing the first substrate; and a liquid crystal layer, including the liquid crystal composition, disposed between the first substrate and the second substrate.

### DETAILED DESCRIPTION

The present disclosure will now be described more fully with reference to exemplary embodiments. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages, features, and how to achieve them of the present invention will become apparent by reference to the embodiment that will be described later in detail, together with the accompanying drawings.

This invention may, however, be embodied in many different forms and should not be limited to the exemplary embodiments. The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

The term “Δ∈” as used herein refers to “dielectric anisotropy”. A “negative dielectric anisotropy” means that the dielectric anisotropy (“Δ∈”) is less than 0.

In an exemplary embodiment, a liquid crystal composition includes an amine light stabilizer including a first compound represented by Formula 1 and a second compound represented by Formula 2, and a liquid crystal:

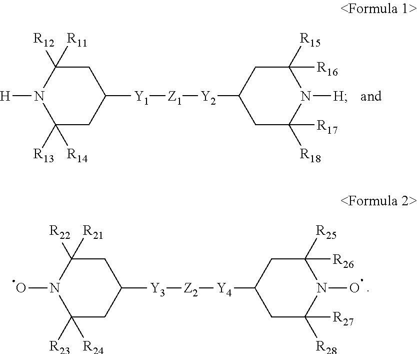

In another exemplary embodiment, in Formulae 1 and 2:

Z₁ and Z₂ may each independently be selected from a substituted or unsubstituted C₁-C₂₀ alkylene group, a substituted or unsubstituted C₂-C₂₀ alkenylene group and a substituted or unsubstituted C₃-C₃₀ cycloalkylene group;

Y₁ to Y₄ may each independently be selected from *—O—*′, *—(C═O)—O—*′, *—O—(C═O)—*′, and *—O—(C═O)—O—*′;

R₁₁ to R₁₈ and R₂₁ to R₂₈ may each independently be selected from hydrogen, a substituted or unsubstituted C₁-C₂₀ alkyl group and a substituted or unsubstituted C₁-C₂₀ alkoxy group;

at least one substituent of the substituted C₁-C₂₀ alkylene group, substituted C₂-C₂₀ alkenylene group, substituted C₃-C₃₀ cycloalkylene group, substituted C₁-C₂₀ alkyl group and substituted C₁-C₂₀ alkoxy group may be selected from fluorine (—F), chlorine (—Cl), bromine (—Br), iodine (—I), a cyano group, a C₁-C₅ alkyl group and a C₁-C₅ alkoxy group;

O. is an oxygen radical; and

each of * and *′ is a binding site to a neighboring atom.

In still another exemplary embodiment, in Formulae 1 and 2:

Z₁ and Z₂ in Formulae 1 and 2 may each independently be selected from: a C₁-C₁₀ alkylene group; and

a C₁-C₁₀ alkylene group, substituted with at least one selected from fluorine (—F), chlorine (—Cl), bromine (—Br), iodine (—I), a cyano group, a C₁-C₅ alkyl group and a C₁-C₅ alkoxy group;

Y₁ to Y₄ may each independently be *—(C═O)—O—*′ or *—O—(C═O)—*′; R₁₁ to R₁₈ and R₂₁ to R₂₈ may each independently be selected from a C₁-C₁₀ alkyl group; and a C₁-C₁₀ alkyl group, substituted with at least one selected from fluorine (—F), chlorine (—Cl), bromine (—Br), iodine (—I), a cyano group, a C₁-C₅ alkyl group and a C₁-C₅ alkoxy group.

In yet another exemplary embodiment, in Formulae 1 and 2:

Z₁ and Z₂ in Formulae 1 and 2 may each independently be selected from a C₆-C₉ alkylene group; and a C₆-C₉ alkylene group, substituted with at least one selected from fluorine (—F), chlorine (—Cl), bromine (—Br), iodine (—I), a cyano group, a C₁-C₅ alkyl group and a C₁-C₅ alkoxy group;

Y₁ to Y₄ may each independently be *—(C═O)—O—*′ or *—O—(C═O)—*′; R₁₁ to R₁₈ and R₂₁ to R₂₈ may each independently be selected from a C₁-C₅ alkyl group; and a C₁-C₅ alkyl group, substituted with at least one selected from fluorine (—F), chlorine (—Cl), bromine (—Br), iodine (—I) a cyano group, a C₁-C₃ alkyl group and a C₁-C₃ alkoxy group.

In still yet another exemplary embodiment, in Formulae 1 and 2:

Z₁ and Z₂ in Formulae 1 and 2 may each independently be selected from a C₆-C₉ alkylene group; and a C₆-C₉ alkylene group, substituted with at least one selected from fluorine (—F), chlorine (—Cl), bromine (—Br), iodine (—I), a cyano group, a C₁-C₅ alkyl group and a C₁-C₅ alkoxy group;

Y₁ to Y₄ may be each independently *—(C═O)—O—*′ or *—O—(C═O)—*′;

R₁₁ to R₁₈ and R₂₁ to R₂₈ may be each independently selected from

a C₁-C₃ alkyl group; and

a C₁-C₃ alkyl group, substituted with at least one selected from fluorine (—F), chlorine (—Cl), bromine (—Br), iodine (—I), a cyano group, a C₁-C₃ alkyl group and a C₁-C₃ alkoxy group, but are not limited thereto.

In another exemplary some embodiment, the first compound may be represented by Formula 1-1 and the second compound may be represented by Formula 2-1:

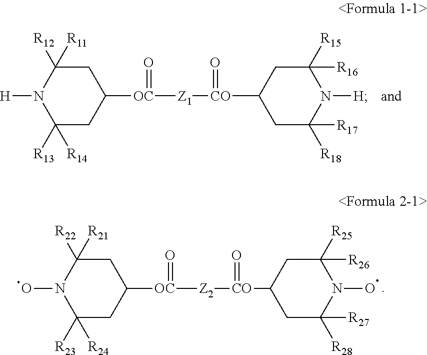

In an aspect of the exemplary embodiment, the descriptions of Z₁, Z₂, R₁₁ to R₁₈ and R₂₁ to R₂₈ in Formulae 1-1 and 2-1 are the same as provided above.

In another exemplary embodiment, in Formulae 1-1 and 2-1:

Z₁ and Z₂ may each independently be selected from a C₆-C₉ alkylene group; and a C₆-C₉ alkylene group, substituted with at least one selected from —F, —Cl, —Br, —I, a cyano group, a C₁-C₅ alkyl group and a C₁-C₅ alkoxy group; and

R₁₁ to R₁₈ and R₂₁ to R₂₈ may be each a methyl group.

In still another exemplary embodiment, the first compound may be Compound A1 and the second compound may be Compound A2:

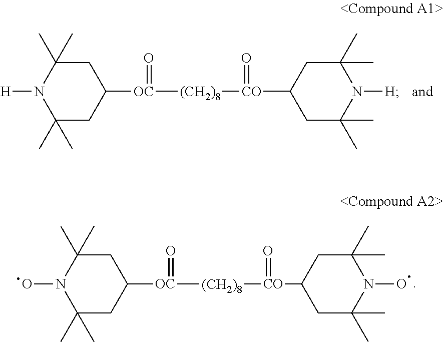

In another exemplary embodiment, due to the inclusion of the amine light stabilizer including the first compound and the second compound, the liquid crystal composition may reduce the amount of radicals or ions generated by the applying of ultraviolet (“UV”) light in the manufacturing course of a liquid crystal display device.

In another exemplary embodiment, in the manufacturing process of a liquid crystal display device, in which a photo-alignment process is employed, when UV light is applied, the concentration of radicals or ions in the liquid crystal composition may be increased. In an aspect of the exemplary embodiment, even when an electric field is applied to a liquid crystal display device, a voltage holding ratio decreases and defects, such as face image sticking or line image sticking may occur, leading to malfunction of the liquid crystal display device.

In another aspect of the exemplary embodiment, due to the exposure to UV light, the concentration of radicals or ions in the liquid crystal composition may be increased according to a mechanism illustrated below in Reaction Scheme 1. However, Reaction Scheme 1 is presented herein as an example illustrating how the concentration of radicals or ions increases in the composition. That is, the mechanism of generating radical or ions by exposure to UV light is not limited thereto.

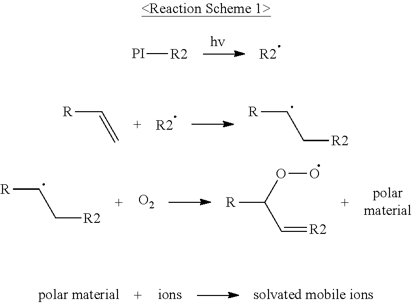

Referring to Reaction Scheme 1, an exemplary embodiment of an alignment film, which will be described below, includes a polyimide (“PI”) resin and the liquid crystal is an alkenyl-based liquid crystal, when the PI resin forming the alignment film is exposed to UV light, a primary radical source is formed, and then, the primary radical source reacts with an alkenyl-based liquid crystal to generate a secondary radical, and then, due to an oxidation reaction, a polar material is formed. The polar material reacts with neighboring ions in the composition for liquid crystal to form a solvated mobile ion in the composition. When the concentration of the mobile ion solvated in the composition increases, a voltage holding ratio decreases, and face image sticking and line image sticking may occur.

In another exemplary embodiment, the amine light stabilizer may react with radicals in the liquid crystal composition while neither affecting unique physical or chemical characteristics of liquid crystal nor causing an additional radical chain reaction. In yet another exemplary embodiment, the amine light stabilizer may prevent radicals from being continuously formed through a Denisov cycle.

When the amine light stabilizer in the liquid crystal composition includes the first compound but does not include the second compound, and a side-reaction may occur according to the mechanism illustrated in Reaction Scheme 2. However, the side-reaction is not limited to this mechanism.

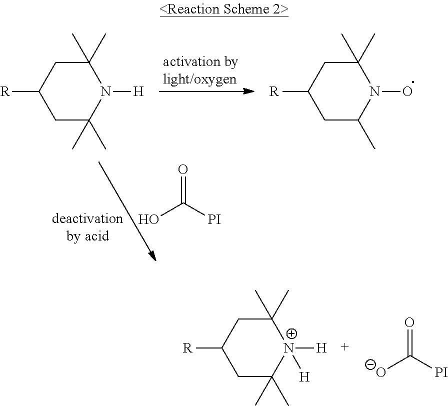

Referring to Reaction Scheme 2, the amine (—NH) group at the end of the first compound may react with a material used in manufacturing a liquid crystal display device, for example, an acid group at the end of the PI resin, forming an alignment film and contributing to an increase in the concentration of ions. The increased concentration of ions may result in line image sticking and face image sticking, and since the amount of the amine light stabilizer that is to be activated is decreased due to the side-reaction, the suppressing of the formation of free radicals by chain reaction may be reduced.

When the amine light stabilizer in the liquid crystal composition includes the second compound but does not include the first compound, the second compound, having oxygen radicals, may contribute to an increase in the concentration of free radicals in the liquid crystal composition.

However, in an exemplary embodiment, the liquid crystal composition includes the amine light stabilizer including the first compound and the second compound. Accordingly, the voltage holding ratio may be increased, and at the same time, the occurrence of the line image sticking and the face image sticking may be reduced.

In an exemplary embodiment, the amine light stabilizer may be present in an amount of about 0.001 to about 0.050 parts by weight, based on 100 parts by weight of the liquid crystal composition. In another exemplary embodiment, the amine light stabilizer may be present in an amount of about 0.005 parts to about 0.040 parts by weight, based on 100 parts by weight of the liquid crystal composition.

When the amount of the amine light stabilizer is within these ranges, the free radicals or ions, which are generated due to the exposure to UV light in the manufacturing process of a liquid crystal display device, may be substantially reduced or removed, and accordingly, the voltage holding ratio (“VHR”) may be increased.

In an exemplary embodiment, a weight ratio of the first compound to the second compound may be in a range of about 1:9 to about 9:1. For example, a weight ratio of the first compound to the second compound may be in a range of about 2:8 to about 8:2.

When the weight ratio of the first compound to the second compound is within these ranges, in comparison to a composition in which only either the first compound or the second compound is used, the occurrence of line image sticking and face image sticking may be reduced.

In an exemplary embodiment, the liquid crystal may have either a negative (−) dielectric anisotropy or a positive (+) dielectric anisotropy. In another exemplary embodiment, the liquid crystal may be a combination of a liquid crystal having a negative (−) dielectric anisotropy and a liquid crystal having a positive (+) dielectric anisotropy.

In an exemplary embodiment, the liquid crystal may have a dielectric anisotropy of about −5.0 to about 9.5

In an exemplary embodiment, the liquid crystal may be included in the liquid crystal layer while being horizontally aligned. In another exemplary embodiment, the liquid crystal may be included in the liquid crystal layer while polymerized in a horizontal alignment state. The term “horizontal alignment” as used herein refers to an optical axis of the liquid crystal layer having an inclination angle of 0 degrees to about 25 degrees, 0 degrees to about 15 degrees, 0 degrees to about 10 degrees, 0 degrees to about 5 degrees, or 0 degrees, with respect to a flat surface of the liquid crystal layer.

In an exemplary embodiment, the liquid crystal may include an alkenyl-based liquid crystal.

In another exemplary embodiment, the alkenyl-based liquid crystal may be a liquid crystal having one alkenyl group.

In yet another exemplary embodiment, the alkenyl-based liquid crystal may be represented by Formula 10 or 11, however. the formula representing the alkenyl-based liquid crystal is not limited thereto:

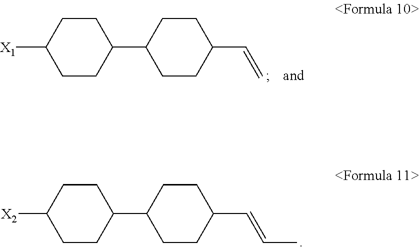

In an aspect of the exemplary embodiment, X₁ and X₂ in Formulae 10 and 11 may each independently be selected from:

a C₁-C₅ alkyl group; and

a C₁-C₅ alkyl group, substituted with at least one selected from fluorine (—F), chlorine (—Cl), bromine (—Br), iodine (—I), a cyano group, a C₁-C₅ alkyl group and a C₁-C₅ alkoxy group.

In an exemplary embodiment, X₁ and X₂ in Formulae 10 and 11 may each independently be a C₁-C₅ alkyl group.

In an exemplary embodiment, the alkenyl-based liquid crystal may be a low-viscosity neutral liquid crystal, and due to the low-viscosity characteristic, the alkenyl-based liquid crystal may have a high response speed.

In an exemplary embodiment, when the liquid crystal composition includes the alkenyl-based liquid crystal, the alkenyl-based liquid crystal may be present in an amount of about 20 parts to about 60 parts by weight, based on 100 parts by weight of the liquid crystal composition. In another exemplary embodiment, the alkenyl-based liquid crystal may be present in an amount of about 25 parts to about 50 parts by weight, based on 100 parts by weight of the liquid crystal composition.

When the amount of the alkenyl-based liquid crystal is within the above ranges, the viscosity of the liquid crystal composition may be adjusted to allow a liquid crystal display device including the liquid crystal composition to have a high response speed.

In an exemplary embodiment, the liquid crystal may further include, in addition to the alkenyl-based liquid crystal, at least one liquid crystal selected from an alkoxy-based liquid crystal, a terphenyl-based liquid crystal and any other known liquid crystal.

In an aspect of the exemplary embodiment, the alkoxy-based liquid crystal may be a liquid crystal having one alkoxy group and the terphenyl-based liquid crystal may be a liquid crystal having one terphenyl group.

In an exemplary embodiment, the liquid crystal may be present in an amount of about 40 parts to about 80 parts by weight, based on 100 parts by weight of the liquid crystal composition.

In another exemplary embodiment, the liquid crystal may be present in an amount of 50 parts to 70 parts by weight, based on 100 parts by weight of the liquid crystal composition.

In an exemplary embodiment, the liquid crystal may have a rotational viscosity of about 85 millipascal seconds (mPa·s) to about 110 mPa·s and a cell gap of about 3.0 micrometers (μm) to about 3.3 micrometers.

In an exemplary embodiment, the liquid crystal composition may further include a reactive mesogen.

In an aspect of the exemplary embodiment, when the liquid crystal composition includes the reactive mesogen, the reactive mesogen may be included in the liquid crystal layer while not yet being hardened, and when subjected to a hardening process by exposure to ultraviolet light, the reactive mesogen may form an alignment film. Thus, in an exemplary embodiment, the reactive mesogen is hardened to form an alignment film and a separate process for forming an alignment film may be omitted.

In an exemplary embodiment, the reactive mesogen may be selected from an acrylate group, a methacrylate group, an epoxy group, an oxetane group, a vinyl-ether group, a styrene group and a thiorene group.

In an exemplary embodiment, when the liquid crystal composition includes the reactive mesogen, the reactive mesogen may be present in an amount of about 0.001 parts to about 0.010 parts by weight, based on 100 parts by weight of the liquid crystal composition. In another exemplary embodiment, the reactive mesogen may be present in an amount of about 0.002 parts to about 0.005 parts by weight, based on 100 parts by weight of the liquid crystal composition.

In an exemplary embodiment, the first compound and the second compound may be synthesized by using known organic synthesis methods. Synthesis methods for the first compound and the second compound may be recognized by one of ordinary skill in the art by referring to the following examples.

Hereinafter, an exemplary embodiment of a liquid crystal display device will be described below.

In an exemplary embodiment, the liquid crystal display device may be a twisted nematic (TN) mode liquid crystal display device, a vertical alignment (VA) mode liquid crystal display device, an in-plane switching (IPS) mode liquid crystal display device, a plane-to-line switching (PLS) mode liquid crystal display device or a fringe field switching (FFS) mode liquid crystal display device, but is not limited thereto.

Hereinafter, an exemplary embodiment of a PLS mode liquid crystal display device will be described. However, the liquid crystal display device is not limited thereto.

In an exemplary embodiment, the liquid crystal display device includes a first substrate, a second substrate facing the first substrate, and a liquid crystal layer disposed between the first substrate and the second substrate, where the liquid crystal layer includes the composition described above.

In another exemplary embodiment, the liquid crystal display device may further include an alignment film.

In an exemplary embodiment, the alignment film may determine an initial alignment direction of a liquid crystal in the liquid crystal layer. In another exemplary embodiment, the alignment film may be formed by using a polymer, such as a polyimide (PI) or a polyamic acid or the like. In another exemplary embodiment, the alignment film may be formed by irradiating light to an alignment assistant, such as reactive mesogen.

In an exemplary embodiment, the liquid crystal display device may include a first substrate, a second substrate facing the first substrate, a liquid crystal layer disposed between the first substrate and the second substrate; a first alignment film disposed between the first substrate and the liquid crystal layer; and a second alignment film disposed between the second substrate and the liquid crystal layer.

In an exemplary embodiment, an array layer, a pixel electrode, a common electrode and the first alignment film may be formed on the first substrate.

In an exemplary embodiment, the first substrate may be a glass substrate; or a plastic substrate, such as polyethylene terephthalate (“PET”), polyethylene naphthalate (“PEN”), polyimide (PI), or the like.

In an exemplary embodiment, the array layer may include a plurality of switching devices. In another exemplary embodiment, the array layer may include a plurality of gate lines and a plurality of data lines.

In an exemplary embodiment, the pixel electrode may be formed on the array layer and may be electrically connected to a switching device of the array layer.

In an exemplary embodiment, the common electrode may be formed on the array layer and may form an electric field together with the pixel electrode to drive the liquid crystal layer. In another exemplary embodiment, the common electrode may include a transparent conductive material. In still another exemplary embodiment, the common electrode may include, for example, a conductive metal oxide, such as indium tin oxide (“ITO”), indium zinc oxide (“IZO”), indium tin zinc oxide (“ITZO”) or the like.

In an exemplary embodiment, the pixel electrode and the common electrode may be formed together on the first substrate and the pixel electrode and the common electrode may be alternately arranged to form a horizontal electric field between the pixel electrode and the common electrode.

In an exemplary embodiment, a black matrix layer, a color filter layer and an over-coating layer may be formed on the second substrate.

In another exemplary embodiment, the black matrix layer may be formed corresponding to a light shielding area of the array layer. In an aspect of the exemplary embodiment, the light shielding area may be defined as an area including a data line, a switching device, and a gate line. Typically, the light shielding area does not include a pixel electrode, and accordingly, liquid crystal molecules are not aligned, thereby causing light leakage. Accordingly, the black matrix layer may be formed in the light shielding area to block the light leakage.

In an exemplary embodiment, the color filter layer may provide color to light passing through the liquid crystal layer, and may include a red (“R”) filter layer, a green (“G”) filter layer, and a blue (“B”) filter layer.

In an exemplary embodiment, the over-coating layer may planarize a top surface of the second substrate.

In an exemplary embodiment, in the liquid crystal display device, the liquid crystal layer may be disposed between the first substrate and the second substrate, and the liquid crystal layer may include a liquid crystal composition, including an amine light stabilizer including the first compound and the second compound and a liquid crystal.

Due to the inclusion of the liquid crystal composition, the liquid crystal display device may less experience line image sticking and face image sticking, thereby having higher reliability.

As used herein, a C₁-C₂₀ alkyl group refers to a linear or branched aliphatic hydrocarbon monovalent group having 1 to 20 carbon atoms, and non-limiting examples thereof are a methyl group, an ethyl group, a propyl group, an iso-butyl group, a sec-butyl group, a tert-butyl group, an n-pentyl group and a hexyl group. A C₁-C₂₀ alkylene group as used herein refers to a divalent group having the same structure as the C₁-C₂₀ alkyl group.

A C₁-C₂₀ alkoxy group as used herein refers to a monovalent group represented by —OA₁₀₁ (where A₁₀₁ is the C₁-C₂₀ alkyl group), and non-limiting examples thereof are a methoxy group, an ethoxy group and an iso-propyloxy group.

A C₂-C₁₈ alkenylene group as used herein refers to a divalent group having at least one carbon double bond in the middle or end of the C₂-C₁₈ alkyl group, and examples non-limiting thereof are an ethenylene group, a prophenylene group, and a butenylene group.

A C₃-C₃₀ cycloalkylene group as used herein refers to a divalent saturated hydrocarbon monocyclic group having 3 to 30 carbon atoms, and non-limiting examples thereof are a cyclopropylene group, a cyclobutylene group, a cyclopentylene group, a cyclohexylene group and a cycloheptylene group.

Hereinafter, exemplary embodiments of a liquid crystal composition will be described. However, the composition is not limited to the following examples.

### EXAMPLES

### Preparation of Examples 1 and 2 and Comparative Examples 1 to 5

A liquid crystal (MERCK® MAT-14-4 liquid crystal) and the liquid crystal compositions shown below in Table 1 were mixed to prepare the liquid crystal compositions corresponding to Examples 1 and 2 and Comparative Examples 1 to 5.

TABLE 1

| | Liquid Crystal Composition | | |
|---|---|---|---|
| | Liquid Crystal | Light Stabilizer | |
| Example 1 | 100 parts by weight | 0.02 parts by weight | 0.01 parts by weight |
| | of liquid crystal | of Compound A1 | of Compound A2 |
| Example 2 | 100 parts by weight | 0.03 parts by weight | 0.01 parts by weight |
| | of liquid crystal | of Compound A1 | of Compound A2 |
| Comparative | 100 parts by weight | 0.02 parts by weight | — |
| Example 1 | of liquid crystal | of Compound A1 | |
| Comparative | 100 parts by weight | 0.03 parts by weight | — |
| Example 2 | of liquid crystal | of Compound A1 | |
| Comparative | 100 parts by weight | — | 0.01 parts by weight |
| Example 3 | of liquid crystal | | of Compound A2 |
| Comparative | 100 parts by weight | — | 0.02 parts by weight |
| Example 4 | of liquid crystal | | of Compound A2 |
| Comparative | 100 parts by weight | 0.02 parts by weight | 0.01 parts by weight |
| Example 5 | of liquid crystal | of Compound (i) | of Compound (ii) |

Compound A1, Compound A2, Compound (i) and Compound (ii) are shown below:

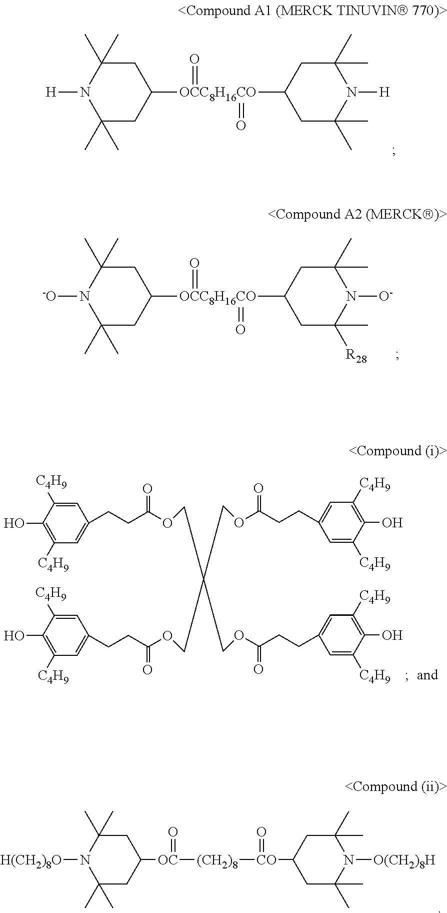

### Evaluation Example

Evaluation for Line Image Sticking

A test display panel including two substrates having field generating electrodes and the composition of Example 1 disposed therebetween was prepared. A plurality of pixels were arranged on the test display panel. From among a plurality of pixels, some pixels alternately arranged horizontally and vertically were marked in black and the other pixels were marked in white, thereby making a black and white lattice pattern. Then, after 60 minutes, the black and white marks were removed, and a time taken until line-shaped spots occur at boundaries of pixels throughout the test display panel while the uniform gray range occurs from black to white, was measured. This time will be referred to herein as “line image sticking-appearance time.” The line image sticking was evaluated according to the following criteria, and evaluation results are shown in Table 2 below. The line image sticking evaluation was performed in the same manner as described above on each of the compositions of Example 2 and Comparative Examples 1 to 5. The line image sticking-appearance time indicates how long a liquid crystal display device is driven without the occurrence of line image sticking. Accordingly, the longer line image sticking-appearance time, the better.

### Line Image Sticking Evaluation Criteria

Good: 168 hours or more

Intermediate: 96 hours or more and less than 168 hours

Bad: less than 96 hours

Evaluation for Face Image Sticking

A glass substrate having a size of 5 cm×5 cm with indium tin oxide (“ITO”) attached thereto was patterned by photolithography in such a manner that the ITO was removed while a square ITO shape having a size of 3 cm×3 cm and an electrode ITO shape for applying a voltage remained. On the patterned ITO substrate, the composition of Example 1 was spin-coated to a thickness of 3.2 micrometers (μm) followed by drying at a temperature of 60 degrees Celsius (° C.), thereby completing the manufacture of a test cell.

The test cell was divided into a pattern to which a higher voltage is to be applied and a pattern to which a lower voltage is to be applied, and each of the patterns was driven for 1 hour. Also, the same voltage was applied to all the patterns to measure a voltage at which a difference in luminance disappears. According to the following criteria, the face image sticking was evaluated. Results thereof are shown below in Table 2. In this regard, when the difference in luminance disappears at a higher voltage, the face image sticking is evaluated as being bad; when the difference in luminance disappears at a lower voltage, the face image sticking is evaluated as being good.

### Face Image Sticking Evaluation Criteria

Good: less than AC 2.45 V

Intermediate: AC 2.45 V or more and less than 2.50V

Bad: AC 2.50 V or more

Evaluation for VHR

A voltage (5 volts (V), 1 Hertz (Hz)) was applied to each of the compositions of Examples 1 and 2 and Comparative Examples 1 to 5 at a temperature of 60° C., and then, a voltage holding ratio (“VHR”) was evaluated according to the following evaluation criteria. Evaluation results are shown in Table 2.

### VHR Evaluation Criteria

Good: 90% or more

Intermediate: 65% or more and less than 90%

Bad: less than 65%

TABLE 2

| | | | Voltage |
|---|---|---|---|
| | Line Image Sticking | Face Image Sticking | Holding Ratio |
| Example 1 | Good | Good | Good |
| Example 2 | Good | Good | Good |
| Comparative | Intermediate | Bad | Bad |
| Example 1 | | | |
| Comparative | Intermediate | Bad | Bad |
| Example 2 | | | |
| Comparative | Bad | Good | Good |
| Example 3 | | | |
| Comparative | Bad | Good | Good |
| Example 4 | | | |
| Comparative | Bad | Intermediate | Good |
| Example 5 | | | |

Referring to Table 2, it was confirmed that the compositions of Examples 1 and 2 were evaluated as “good” in the evaluation of line image sticking, face image sticking and VHR.

However, the compositions of Comparative Examples 1 and 2 were evaluated as “bad” in the items of face image sticking and the compositions of Comparative Examples 3 to 5 were evaluated as “bad” in the evaluation of line image sticking. Accordingly, it was confirmed that the compositions of Comparative Examples 1 to 5 were inappropriate for use in a liquid crystal display device.

According to an exemplary embodiment, a composition for liquid crystal and a liquid crystal display device including the same, two or more different amine light stabilizers contribute to the decrease in the concentration of free radicals or ions generated due to the absorption of ultraviolet (UV) light, leading to a decrease in the occurrence of face image sticking and line image sticking.

While the inventive concept has been particularly shown and described with reference to exemplary embodiments thereof, it will be understood by those of ordinary skill in the art that various changes in form and details may be made therein without departing from the spirit and scope as defined by the following claims.

What is claimed is:

1. A liquid crystal composition comprising:
an amine light stabilizer comprising a first compound represented by Formula 1 and a second compound represented by Formula 2; and
a liquid crystal: 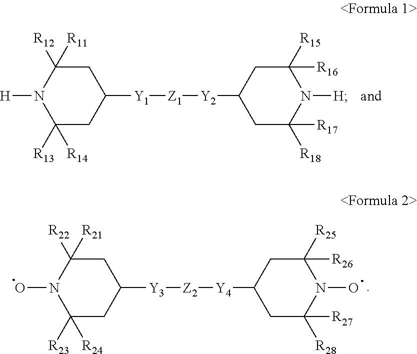
wherein, in Formulae 1 and 2,
Z₁ and Z₂ are each independently selected from a substituted or unsubstituted C₁-C₂₀ alkylene group, a substituted or unsubstituted C₂-C₂₀ alkenylene group and a substituted or unsubstituted C₃-C₃₀ cycloalkylene group;
Y₁ to Y₄ are each independently selected from *—O—*′, *—(C═O)—O—*′, *—O—(C═O)—*′, and *—O—(C═O)—O—*′;
R₁₁ to R₁₈ and R₂₁ to R₂₈ are each independently selected from hydrogen, a substituted or unsubstituted C₁-C₂₀ alkyl group and a substituted or unsubstituted C₁-C₂₀ alkoxy group,
at least one substituent of the substituted C₁-C₂₀ alkylene group, substituted C₂-C₂₀ alkenylene group, substituted C₃-C₃₀ cycloalkylene group, substituted C₁-C₂₀ alkyl group, and substituted C₁-C₂₀ alkoxy group is selected from fluorine, chlorine, bromine, iodine,—a cyano group, a C₁-C₅ alkyl group and a C₁-C₅ alkoxy group;
O. is an oxygen radical; and
each of * and *′ is a binding site to a neighboring atom.

2. The liquid crystal composition of claim 1, wherein:
Z₁ and Z₂ are each independently selected from
a C₁-C₁₀ alkylene group; and
a C₁-C₁₀ alkylene group, substituted with at least one selected from fluorine, chlorine, bromine, iodine, a cyano group, a C₁-C₅ alkyl group and a C₁-C₅ alkoxy group,
Y₁ to Y₄ are each independently *—(C═O)—O—*′ or * —O—(C═O)—*′, and
R₁₁ to R₁₈ and R₂₁ to R₂₈ are each independently selected from
a C₁-C₁₀ alkyl group; and
a C₁-C₁₀ alkyl group, substituted with at least one selected from fluorine, chlorine, bromine, iodine, a cyano group, a C₁-C₅ alkyl group and a C₁-C₅ alkoxy group.

3. The liquid crystal composition of claim 1, wherein:
Z₁ and Z₂ are each independently selected from
a C₆-C₉ alkylene group; and
a C₆-C₉ alkylene group, substituted with at least one selected from fluorine, chlorine, bromine, iodine, a cyano group, a C₁-C₅ alkyl group and a C₁-C₅ alkoxy group,
Y₁ to Y₄ are each independently *—(C═O)—O—*′ or *—O—(C═O)—*′, and
R₁₁ to R₁₈ and R₂₁ to R₂₈ are each independently selected from
a C₁-C₅ alkyl group; and
a C₁-C₅ alkyl group, substituted with at least one selected from fluorine, chlorine, bromine, iodine, a cyano group, a C₁-C₃ alkyl group and a C₁-C₃ alkoxy group.

4. The liquid crystal composition of claim 1, wherein
Z₁ and Z₂ are each independently selected from
a C₆-C₉ alkylene group; and
a C₆-C₉ alkylene group, substituted with at least one selected from fluorine, chlorine, bromine, iodine, a cyano group, a C₁-C₅ alkyl group and a C₁-C₅ alkoxy group,
Y₁ to Y₄ are each independently *—(C═O)—O—*′ or *—O—(C═O)—*′, and
R₁₁ to R₁₈ and R₂₁ to R₂₈ are each independently selected from
a C₁-C₃ alkyl group; and
a C₁-C₃ alkyl group, substituted with at least one selected from fluorine, chlorine, bromine, iodine, a cyano group, a C₁-C₃ alkyl group and a C₁-C₃ alkoxy group.

5. The liquid crystal composition of claim 1, wherein
the first compound is represented by Formula 1-1, and the second compound is represented by Formula 2-1: 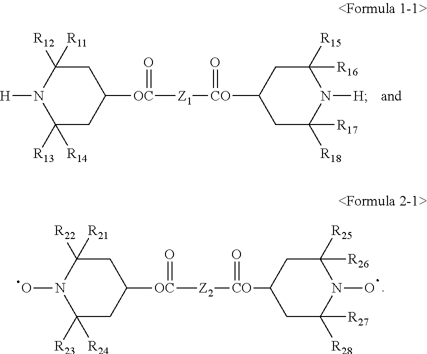
wherein, in Formulae 1-1 and 2-1,
Z₁ and Z₂ are each independently selected from a substituted or unsubstituted C₁-C₂₀ alkylene group, a substituted or unsubstituted C₂-C₂₀ alkenylene group and a substituted or unsubstituted C₃-C₃₀ cycloalkylene group;
R₁₁ to R₁₈ and R₂₁ to R₂₈ are each independently selected from hydrogen, a substituted or unsubstituted C₁-C₂₀ alkyl group and a substituted or unsubstituted C₁-C₂₀ alkoxy group,
at least one substituent of the substituted C₁-C₂₀ alkylene group, substituted C₂-C₂₀ alkenylene group, substituted C₃-C₃₀ cycloalkylene group, substituted C₁-C₂₀ alkyl group and substituted C₁-C₂₀ alkoxy group is selected from fluorine, chlorine, bromine, iodine, a cyano group, a C₁-C₅ alkyl group and a C₁-C₅ alkoxy group; and
O. is an oxygen radical.

6. The liquid crystal composition of claim 1, wherein
the amine light stabilizer is present in an amount of about 0.001 to about 0.05 parts by weight, based on 100 parts by weight of the liquid crystal composition.

7. The composition of claim 1, wherein
a weight ratio of the first compound to the second compound is about 2:8 to about 2:8.

8. The liquid crystal composition of claim 1, wherein
the liquid crystal has a negative dielectric anisotropy.

9. The liquid crystal composition of claim 1, wherein the liquid crystal has a dielectric anisotropy of about −0.5 to about 9.5.

10. The liquid crystal composition of claim 1, wherein
the liquid crystal comprises at least one selected from an alkenyl-based liquid crystal, an alkoxy-based liquid crystal and a terphenyl-based liquid crystal.

11. The liquid crystal composition of claim 10, wherein
the alkenyl-based liquid crystal is represented by Formula 10 or 11: 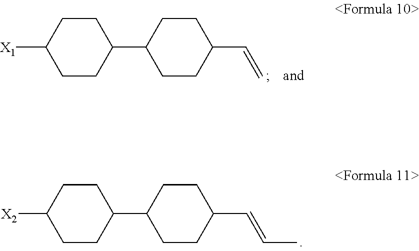
wherein X₁ and X₂ in Formulae 10 and 11 are each independently selected from
a C₁-C₅ alkyl group; and
a C₁-C₅ alkyl group, substituted with at least one selected from fluorine, chlorine, bromine, iodine, a cyano group, a C₁-C₅ alkyl group and a C₁-C₅ alkoxy group.

12. The liquid crystal composition of claim 10, wherein
the liquid crystal comprises the alkenyl-based liquid crystal, and the alkenyl-based liquid crystal is present in an amount of about 20 to about 60 parts by weight, based on 100 parts by weight of the liquid crystal composition.

13. The liquid crystal composition of claim 1, wherein
the liquid crystal is present in an amount of about 40 to about 80 parts by weight based, on 100 parts by weight of the liquid crystal composition.

14. The liquid crystal composition of claim 1, wherein
the liquid crystal has a rotational viscosity of about 85 to about 110 milli-Pascal/second and a cell gap of about 3.0 micrometers to about 3.3 micrometers.

15. The liquid crystal composition of claim 1, further comprising
a reactive mesogen.

16. A liquid crystal display device, comprising:
a first substrate;
a second substrate facing the first substrate; and
a liquid crystal layer disposed between the first substrate and the second substrate,
wherein the liquid crystal layer comprises the liquid crystal composition of claim 1.

17. The liquid crystal display device of claim 16, further comprising at least one of
a first alignment layer disposed between the first substrate and the liquid crystal layer; and
a second alignment layer disposed between the second substrate and the liquid crystal layer.

18. The liquid crystal display device of claim 16,: further comprising
a color filter disposed on one of the first substrate and the second substrate; and
an array layer disposed on the other of the first substrate and the second substrate.

19. The liquid crystal display device of claim 16, further comprising
a pixel electrode and a common electrode, each disposed on the first substrate.

20. The liquid crystal display device of claim 19, wherein
the pixel electrode and the common electrode are alternately arranged to generate a horizontal electric field therebetween.
